(19) United States
(12) Patent Application Publication
(10) Pub. No.: US 2023/0383559 A1
(43) Pub. Date: Nov. 30, 2023

(54) RECEIVING DEVICE FOR DEPOSITING SLINGING MEANS ON A DISTRIBUTION MAST AND DISTRIBUTION MAST

(71) Applicant: Schwing GmbH, Herne (DE)

(72) Inventors: Rudolf Rabsahl, Dortmund (DE); Boris Streier, Recklinghausen (DE)

(21) Appl. No.: 18/203,410

(22) Filed: May 30, 2023

(30) Foreign Application Priority Data
May 30, 2022 (DE) 10 2022 113 589.6

(51) Int. Cl. E04G 21/04; B66C 23/26; B66C 23/64

(52) U.S. Cl. CPC E04G 21/0445; B66C 23/26; B66C 23/64

(57) ABSTRACT

The disclosure relates to a receiving device for depositing a slinging means on a distribution mast, wherein the slinging means is designed for lifting and transporting the distribution mast and wherein the slinging means has two carrying ends. For example, the disclosure is characterized in that the receiving device is designed for receiving in a length-variable manner at least one of the carrying ends of the slinging means.

In addition, the disclosure relates to a distribution mast with a receiving device for depositing a slinging means which is designed for lifting and transporting the distribution mast.

### FIELD OF THE DISCLOSURE

The disclosure relates to a receiving device for depositing a slinging means on a distribution mast, the slinging means being designed for lifting and transporting the distribution mast. In addition, the disclosure relates to a distribution mast with a receiving device for a slinging means, which is designed for lifting and transporting the distribution mast.

### BACKGROUND

A distribution mast consisting of several mast segments, which is usually used on construction sites for spreading concrete, but can also be used for other applications, for example for distributing biomass or liquids in a field, is usually lifted by a crane with suitable slinging means, for example two or more steel ropes, chains or also nylon cables or straps or similar suitable slinging means and bolted to a partial segment of a mast segment or, if the entire distribution mast is lifted with the turntable, mounted on a substructure, for example a support column or a lattice tower. The folded-in mast package of a distribution mast can also be hung into the turntable of the distribution mast, as described, for example, in patent application DE 10 2012 224 529 A1.

For this purpose, the distribution mast or the folded-in mast package of the distribution mast, as shown for example in FIGS. 1 and 2, is lifted by a crane by means of two or more slinging means, which are hung into the end of the first mast segment on the turntable side (foot section) and into the end of the first mast segment facing away from the turntable (head section) at attachment points provided for this purpose. In the area of the turntable, there is a working platform for the assembly of the distribution mast, in order to connect the concrete delivery line, hydraulic lines, if necessary further mast segments of the mast package etc. for the working operation of the distribution mast after the assembly of the mast package.

After the hung into or the bolting of the mast package of the distribution mast, the slinging means used to lift the folded mast package must be removed for operation. The problem here is that the slinging means which is hooked into the outer end of the mast package for transport cannot be reached or can only be reached with great difficulty and therefore cannot be unhooked easily. In contrast, the slinging means can be easily unhooked and removed in the area of the turntable, where the working platform is also located.

According to the prior art, the slinging means that is hung into the area of the working platform is first removed. The slinging means that is hung into the more distant end of the mast package is simply deposited on the distribution mast and remains hung into the inaccessible attachment point. To remove the slinging means completely, however, it can also be unhooked in an elaborate way, for example using a personnel cage suspended from the crane.

If the slinging means remains loose on the mast package, it may damage the surfaces of the mast segments, especially the first mast segment, or fall down with one end due to the movements of the distribution mast during working operation.

The loose end of the slinging means cannot easily be hung or rigidly attached into the area of the turntable because the mast segment deflects during operation. This means that the slinging means would have to be loosely hooked in or laid down, so that it can continue to slide back and forth on the mast segments and damage the surfaces there.

### SUMMARY

The disclosure relates to a receiving device for depositing a slinging means on a distribution mast, wherein the slinging means is designed for lifting and transporting the distribution mast and wherein the slinging means has two carrying ends.

In addition, the disclosure relates to a distribution mast with a receiving device for depositing a slinging means which is designed for lifting and transporting the distribution mast.

### BRIEF DESCRIPTION OF THE DRAWINGS

FIG. 1 shows a distribution mast with a receiving device according to the disclosure in a first assembly variant,

FIG. 2 shows a distribution mast with a receiving device according to the disclosure in a second assembly variant,

FIG. 3 shows a view of an assembled distribution mast with the slinging means deposited according to the disclosure,

FIG. 4 shows a first embodiment of the receiving device according to the disclosure during transport of the distribution mast,

FIG. 5 shows the first embodiment of the receiving device according to the disclosure with deposited slinging means,

FIG. 6 shows a second embodiment of the receiving device according to the disclosure during receiving of the slinging means,

FIG. 7 shows the second embodiment of the receiving device according to the disclosure after receiving the slinging means,

FIG. 8a, b shows top view and side view of a variant of the first embodiment of the receiving device according to the disclosure, and

FIG. 9a, b shows side view of a third embodiment of the receiving device according to the disclosure.

### DESCRIPTION OF THE SPECIFIC EMBODIMENTS

The present disclosure relates to a receiving device for depositing a slinging means on a distribution mast with the features of claim 1 and a distribution mast with a corresponding device according to claim 8.

The receiving device according to the disclosure for depositing a slinging means on a distribution mast is based on the knowledge that a length-variable receiving device for the at least one carrying end of the slinging means prevents stretching and thus damage to the slinging means in the event of deflection of the distribution mast during working operation. For the purposes of the disclosure, “length-variable receiving devices” means that at least one carrying end of the slinging means is movable in the longitudinal direction in relation to the mast segment of the distribution mast on which the slinging means is deposited.

For example, the slinging means with the first carrying end remains hung into the distribution mast at an attachment point after the distribution mast has been transported, and the receiving device is designed to receive the second carrying end of the slinging means in a length-variable manner.

According to a first embodiment of the disclosure, the slinging means is designed as a supporting rod. In contrast to a slinging means designed as a rope or chain, a supporting rod is rigid and can simply be deposited with at least one carrying end on the receiving device without the rod sagging significantly and thus contacting the surface of the distribution mast during operation of the distribution mast and thus causing damage there.

For example, the receiving device has a depositing surface which is designed for length-variable receiving the second end of the slinging means. By using a depositing surface on which the second end of the slinging means is deposited, the supporting rod does not rest directly on the distribution mast and thus cannot cause any damage on the distribution mast. In addition, the depositing surface allows the supporting rod to be placed at a certain distance from the surface of the distribution mast, so that the supporting rod, even if it sags somewhat, cannot contact the surface of the distribution mast and thus cannot cause damage.

For example, the receiving device has lateral guides that are designed to laterally guide the second end of the supporting rod. The lateral guides prevent the supporting rod from slipping laterally from the depositing surface onto the surface of the distribution mast and thus causing damage there.

For example, the receiving device has means designed to secure the second end of the supporting rod on the receiving device. These securing means prevent the second end of the supporting rod from becoming detached from the receiving device even during faster up and down movements of the distribution mast or when the distribution mast is moved, for example, into a vertical position.

According to a second embodiment of the disclosure, the slinging means is flexible, for example a carrying rope or chain, and the receiving device is designed as a tensioning device which is designed to receive the second end of the slinging means in a length-variable manner. The tensioning device provides length compensation during operation of the distribution mast so that the slinging means is held at almost constant tension and at a certain distance from the surface of the distribution mast and deflection of the distribution mast does not lead to overstretching of the slinging means.

The disclosure is further characterized by a distribution mast having a receiving device for depositing a slinging means, the slinging means being configured for lifting and transporting the distribution mast and having two ends and remains hung into to the distribution mast with a first of the two ends after transport, the receiving device being configured for receiving the second end of the sling means in a length-variable manner.

### DETAILED DESCRIPTION OF THE DRAWINGS

FIG. 1 shows a distribution mast 1 with a receiving device 25, 30 according to the disclosure in a first assembly variant. That is, prior to assembly, the distribution mast 1 in this variant is divided into two assembly complexes, one assembly complex consisting of a support column 4 with a turntable 3 mounted thereon. The support column 4 can be several meters high, so that the turntable 3 is located at a great height above the ground or, for example, above the floor ceiling of a building on which the distribution mast 1 is to be used. The turntable 3 is rotatably connected to the support column 4 via a slewing ring 7. A partial segment 10a of the first mast segment 10 is connected to the turntable 3 via a swivel joint 6. A working platform 5 with a railing is arranged in the area of the turntable 3. The second assembly complex of the distribution mast 1 consists of the folded-in mast package 2. In this example, the mast package 2 consists of the first partial mast segment 10b, the second mast segment 11 and the third mast segment 12 and, if necessary, further mast segments not shown in the figure, each of which is connected to one another for pivoting movement via articulated joints 14, 15. In working operation, the first mast segment 10 is pivoted relative to the turntable 3 and the mast segments 10, 11, 12 are pivoted relative to each other via articulated drives not shown, for example hydraulic cylinders. The mast package 2 may consist of more but also of fewer mast segments 10, 11, 12 connected to each other in a pivotable manner. A conveying line not shown is arranged through or along the support column 4, which leads through or along the turntable 3 to the mast package 2 and there along the mast segments 10, 11, 12 to the mast top, in order to discharge fresh concrete or other thick materials or liquids there via an end hose not shown during working operation with the unfolded mast.

On the upper side of the first partial mast segment 10b or, in the case of another type of folding of the mast package 2 not shown here, on the upper side of another mast segment, two attachment points 23a and 23b are arranged for slinging means 20 and 21 for lifting and transporting the mast package 2 of the distribution mast 1. The attachment point 23a is located at the head of the first mast segment 10 relatively far away from the turntable 3 with the working platform 5.

The slinging means 21 is hung with its first carrying end 21b into the attachment point 23a. During the transport process, the slinging means 21 is hung with its second carrying end 21a into a crane hook 22. A further slinging means 20 is hung with its first carrying end 20b into the second attachment point 23b and with its second carrying end 20a into the crane hook 22. In this way, a crane can be used to bring the mast package 2 up to the already mounted turntable 3. The two partial mast segments 10a and 10b are then guided towards each other so that they can be bolted together via the bolt connection 13.

The second carrying end 21b of the slinging means 21 cannot be reached by an installer from the working platform 5, so this carrying end 21b remains hooked into the attachment point 23a after installation.

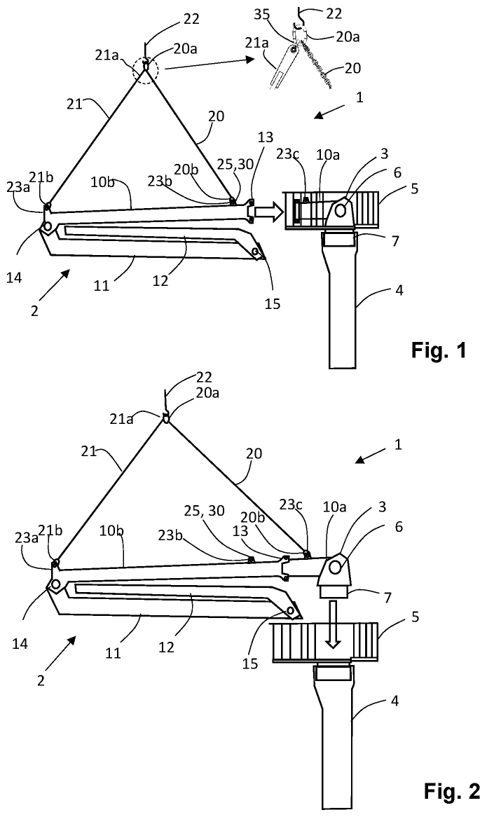

FIG. 2 shows an assembly variant in which the mast package 2 is lifted together with the turntable 3 and transported onto the support column 4. This variant is preferably used, for example, if a crane is available that can lift a larger load. In this way, the bolt connection 13 of the partial mast segments 10a and 10b can be established on the ground before lifting. In this variant, a third attachment point 23c on the partial mast segment 10a or on the turntable is used for the slinging means 20, which allows the mast package 2 with the turntable 3 to be better balanced on the crane hook 22 during transport. For the two transport variants, the slinging means 20 can be changed in length, for example, or slinging means 20 with different lengths are used for each of the two transport variants. As already explained in connection with FIG. 1, after assembly of the distribution mast 1, the slinging means 21 remains hung with the first carrying end 21b into the attachment point 23a.

Depending on the design of the distribution mast 1, there are further mounting options, for example, the mast package 2 may be hung into the turntable 3 as shown in patent application DE 10 2012 224 529 A1.

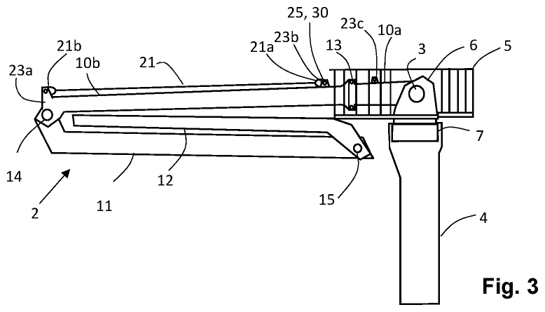

FIG. 3 shows the fully assembled distribution mast 1 with a receiving device 25, 30 according to the disclosure for depositing the slinging means on the distribution mast 1. The receiving device 25, 30 is designed for depositing the slinging means 21 on the distribution mast 1, wherein the slinging means 21 is designed for lifting and transporting the distribution mast 1 and has two carrying ends 21a, 21b, wherein the receiving device 25, 30, 39 is designed for receiving at least one of the carrying ends 21a, 21b of the slinging means 21 in a length-variable manner. In the embodiment shown in FIG. 3, the slinging means 21 is designed for lifting and transporting the distribution mast 1 and has two carrying ends 21a, 21b and remains hung with a first of the two carrying ends 21b into the attachment point 23a of the distribution mast 1 after transport. The receiving device 25, 30 is designed to receive the second carrying end 21a of the slinging means 21 in a length-variable manner. The receiving device 25, 30 is located close to the working platform 5 so that an installer can attach or deposit the second carrying end 21a of the slinging means 21 on the receiving device 25, 30.

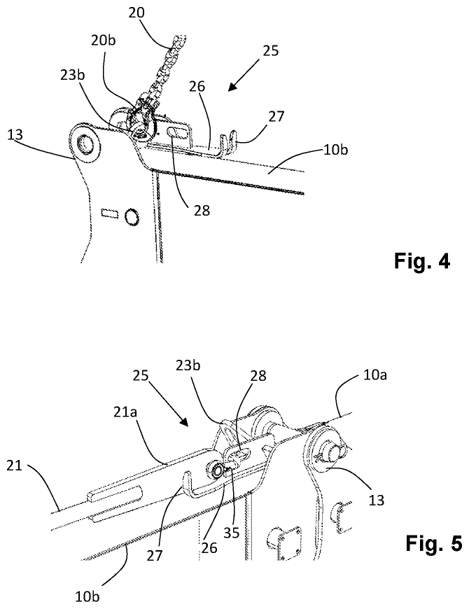

FIGS. 4 and 5 show a receiving device 25 according to the disclosure, which is designed for receiving the slinging means 21 in a length-variable manner, the slinging means 21 is designed as a supporting rod 21 in this first variant. FIG. 4 shows the mast package 2 during transport on a crane hook 22, as described in connection with FIG. 1. The slinging means 20, in this case a chain, is still hooked into the attachment point 23b with the carrying end 20b, which in this case is designed as a load hook.

After the distribution mast 1 has been mounted, the slinging means 21, which is designed as a supporting rod 21, is placed with its second carrying end 21a in a length-variable manner on the depositing surface 26 of the receiving device 25 with the aid of the crane hook 22. To prevent the supporting rod 21 with the second carrying end 21a from slipping sideways off the depositing surface 26, this carrying end 21a is guided by two lateral guides 27. The receiving device 25 has means 28, 35 which are designed to secure the second carrying end 21a of the supporting rod 21 on the receiving device 25. In the example shown here, these means 28, 35 comprise a shackle 35 which connects the lifting eye of the second carrying end 21a of the supporting rod 21 to an oblong hole 28. When the mast segment 10a with the supporting rod 21 now placed thereon in a length-variable manner bends during operation, the second carrying end 21a can move back and forth somewhat on the receiving device 25 so that the supporting rod 21 is not subjected to elongation that could lead to damage or breakage of the supporting rod 21. In addition, the supporting rod 21 does not contact the surface of the mast segment 10b and thus cannot cause damage to the surface of the mast segment 10b. After the supporting rod 21 has been deposited, the slinging means 20 is released from the attachment point 23b and removed.

FIG. 5 also shows that the attachment point 23b is arranged somewhat laterally offset in the longitudinal direction of the mast. This compensates for an asymmetrical mass distribution of the mast package 2 so that the mast package 2 hangs horizontally from the slinging means 20, 21 during transport and can be easily mounted.

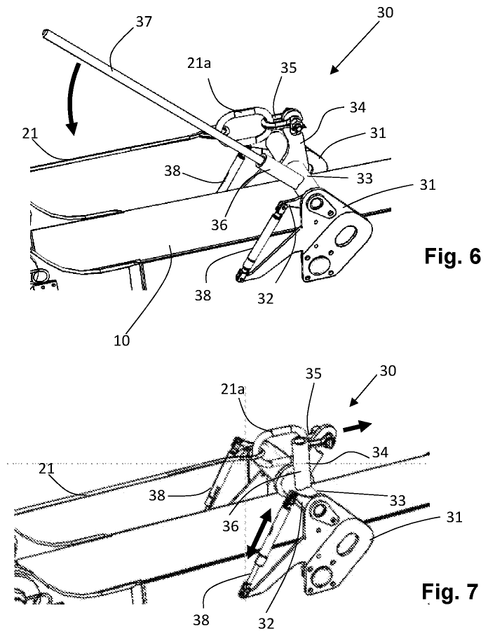

FIGS. 6 and 7 show a receiving device 30 according to the disclosure in a second embodiment, in which the slinging means 21 are designed as a steel/carrying rope, steel chain, nylon strap, nylon rope or the like, and the receiving device 30 is designed as a tensioning device 30, which is designed to receive the second carrying end 21a of the slinging means 21 in a length-variable manner. The receiving device 30 designed as a tensioning device 30 is designed for tensioning the slinging means 21 received therein, the tensioning of the slinging means 21 also being to be understood as depositing in the sense of the disclosure. This second variant is for example if the slinging means 21, in contrast to a supporting rod 21, sags considerably in the untensioned state.

The tensioning device 30 shown here as an example consists of two retaining plates 31 welded perpendicular to the side of the mast segment 10, for example, which project with one section beyond the top of the mast segment 10. Between the two retaining plates 31, a tube 33 is rotatably arranged above the mast segment 10 transversely to the longitudinal direction of the mast. Tensioning levers 32 are arranged on both sides of the rotatably mounted tube 33 and are pressed upwards by compression springs 38. A further tensioning lever 34 is arranged approximately in the middle of the tube 33 and is directed upwards away from the surface of the mast segment 10. In addition, a receptacle 36 for a tensioning rod 37 is arranged on the tube 33.

FIG. 6 shows the tensioning device 30 during the process of hooking the carrying rope 21 onto the tensioning device 30. For hooking in the second end 21a of the carrying rope 21, which in this case is formed by an oval ring 21a, the tensioning device 30 is pretensioned by pressing down the tensioning rod 37 inserted into the receptacle 36, whereby the compression springs 38 are compressed. The tensioning lever 34 is thereby brought up to the second end 21a of the slinging means 21, and the tensioning lever 34 can be connected to the second end 21a of the slinging means 21, for example, by means of a shackle 35. As soon as no more pressure is applied to the tensioning rod 37, the two compression springs 38 push the tensioning lever 34 to the right via the tube 33 in FIG. 6, thereby tensioning the suspension rope 21, which is hung into to the attachment point 23a with its first carrying end 21b. FIG. 7 shows the tensioning device 30 at the end of the tensioning process, after the tensioning rod 37 required for tensioning has been removed from the receptacle.

The tensioned carrying rope 21 now runs above the upper surface of the mast segment 10b and does not touch its surface, and therefore can no longer cause damage. Moreover, the tensioning device 30 accommodates the second carrying end 21a of the carrying rope 21 in a length-variable manner, so that any deflection of the mast segment 10 during working operation is compensated for by the tensioning device 30 without stretching the tensioned carrying rope 21. Even if the mast segment 10 is bent upwards by vertical vibrations of the mast segments 10,11,12 during working operation of the distribution mast 1, the tensioning device 30 maintains the tension of the carrying rope 21. The tensioning force of the tensioning device 30 is selected in such a way that surface contact of the carrying rope 21 or the chain 21 is avoided, but yielding is possible when the distribution mast 1, or the first mast segment 10, bends without overloading the suspension rope 21.

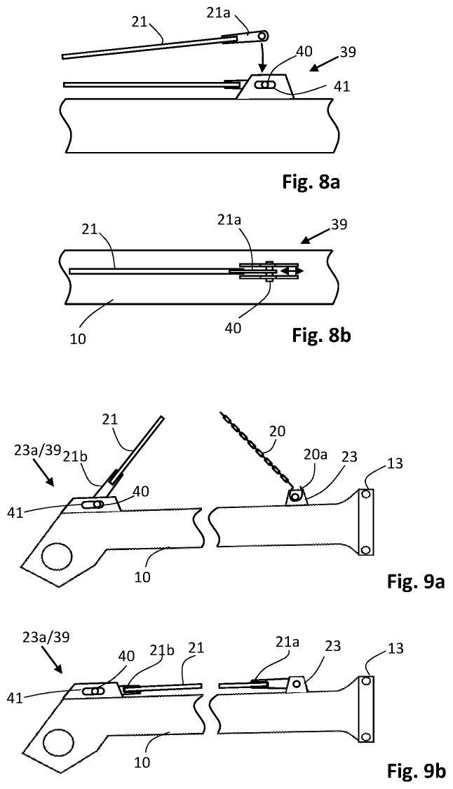

FIGS. 8a and 8b show a side view (FIG. 8a) and a top view (FIG. 8b) of a variant of the first embodiment of the receiving device 25 according to the disclosure, in which the slinging means 21 is designed as a supporting rod. In this variant, the second carrying end 21a of the slinging means 21 is bolted to a bolt 40 in the receiving device 39, in which a horizontally aligned oblong hole 41 is made, so that the second carrying end 21a of the slinging means 21 is received by the receiving device 25 in a length-variable manner. As an alternative to the oblong hole 41, a bore could also be provided in the receiving device 39, the diameter of which is larger than the diameter of the bolt 40, so that a certain clearance is provided for length-variable reception.

FIGS. 9a and 9b show a further variant of the receiving device 39 according to the disclosure, in which the first carrying end 21b of a supporting rod 21 is received by the receiving device 39 in a length-variable manner. In this variant, for example, an oblong hole 41 is located at the region remote from the working platform 5 of the folded-in distribution mast 1, with which the mast package 2 is also supported. The first carrying end 21b is connected to the receiving device 39 by means of a bolt 40, whereby the receiving device 39 on the one hand, due to the oblong hole 41, enables the slinging means 21 to be deposited in a length-variable manner, but on the other hand also has the function of an attachment point 23a. This means that the first carrying end 21b is hung into the attachment point 23 for transport and is also accommodated there in a length-variable manner when it is deposited at this point. The second carrying end 21b of the supporting rod 21 can then, for example, be firmly connected, for example as shown in FIG. 9b, to the attachment point 23 or to another support which does not necessarily have to enable the second end 21a of the supporting rod 21 to be accommodated in a length-variable manner.

In a further variant not shown in the figures, which is also possible for example for slack slinging means 20, 21 such as ropes or chains, the receiving device according to the disclosure for length-variable receiving of at least one carrying end 21a, b of a slinging means 21 can be designed in such a way, in that the attachment point 23a remote from the rotating tower has a simple spring mechanism for tensioning the slinging means 21 at the first carrying end 21b, and a tensioning device, similar to that in FIGS. 6 and 7, is arranged at the second carrying end 21a for receiving the second carrying end 21a, it then no longer being necessary for this tensioning device to be spring-actuated.

As an alternative to attaching the slinging means 20, 21 to attachment points 23a, b, c on the upper side of the mast package 2, slinging means 20, 21 arranged in parallel, i.e. in duplicate, could also be hooked in each case laterally to the mast package 2 or to one of the mast segments 10, 11, 12, for transport and, in accordance with the disclosure described here, could also be deposited in each case laterally on receiving devices 25, 30.

In addition, the slinging means 20, 21, for example the slinging means 21 deposited in the receiving device 25, 30, 39 in a length-variable manner, could also be designed with double ends or as a combination of rope/chain and rod or the like.

The receiving device 25, 30, 39 according to the disclosure has been illustrated here using the example of a distribution mast 1 in which the mast segments 10, 11, 12 of the mast package 2 are folded downwards in the transport state. The disclosure is equally applicable to distribution masts 1 in which the mast package 1 comprises mast segments 10, 11, 12 which are at least partially folded upwards. The receiving device 25, 30 for the slinging means 21 is then not located on the surface of the first mast segment 10, but could for example also be arranged on the surface of another mast segment 11, 12.

The disclosure provides a solution for the deposit of a slinging means of a distribution mast, so that the slinging means, after it has fulfilled its transport task, can remain hung into one end on the distribution mast and can be fastened or deposited at the other end in such a way that it is not stretched by the deflection of the distribution mast during operation, or causes damage to the surface of the distribution mast or absorbs forces.

### LIST OF REFERENCE

1 distribution mast
2 mast package
3 turntable
4 support column
5 working platform
6 swivel joint
7 slewing ring
10a, b partial mast segment
10 first mast segment
11 second mast segment
12 third mast segment
13 bolt connection
14 articulated joint
15 articulated joint
20 slinging means with carrying ends 20a, 20b
21 slinging means with carrying ends 21a, 21b
22 crane hook
23a, b, c attachment points
25 receiving device (first embodiment of the disclosure)
26 depositing surface
27 lateral guides
28 oblong hole
30 receiving device (second embodiment of the disclosure)
31 retaining plate
32 first tensioning lever
33 pipe
34 second tensioning lever
35 shackle
36 receptacle
37 tensioning rod
38 compression spring
39 receiving device (third embodiment)
40 bolt
41 oblong hole

1. Receiving device for depositing a slinging means on a distribution mast, wherein the slinging means is designed for lifting and transporting the distribution mast and has a first and a second carrying end,
wherein
the receiving device is designed for receiving at least one of the carrying ends of the slinging means in a length-variable manner.

2. Receiving device according to claim 1, wherein the slinging means remains with the first carrying end hung into an attachment point on the distribution mast after the transport of the distribution mast and that the receiving device is designed for receiving the second carrying end of the slinging means in a length-variable manner.

3. Receiving device according to claim 1, wherein the slinging means is designed as a supporting rod.

4. Receiving device according to claim 3, wherein the receiving device has a depositing surface which is designed for length-variable deposit of the second carrying end of the slinging means.

5. Receiving device according to claim 4, wherein the receiving device has lateral guides which are designed for lateral guidance of the second carrying end of the supporting rod.

6. Receiving device according to claim 5, wherein the receiving device comprises means designed to secure the second carrying end of the supporting rod on the receiving device.

7. Receiving device according to claim 1, wherein the slinging means is a carrying rope or a chain and that the receiving device is designed as a tensioning device which is designed for receiving at least one carrying end of the slinging means in a length-variable manner.

8. Receiving device according to claim 7, wherein the tensioning device is designed for tensioning the slinging means.

9. Distribution mast with a receiving device for depositing a slinging means, wherein the slinging means is designed for lifting and transporting the distribution mast and has two carrying ends,
wherein
the receiving device is designed for receiving at least one of the two carrying ends of the slinging means in a length-variable manner.

10. Distribution mast according to claim 9, wherein the receiving device is designed for receiving the second carrying end of the slinging means in a length-variable manner.
